(19) United States
(12) Patent Application Publication
(10) Pub. No.: US 2025/0246340 A1
(43) Pub. Date: Jul. 31, 2025

(54) WIRE HARNESS

(71) Applicant: Yazaki Corporation, Tokyo (JP)

(72) Inventors: Toshiharu TAKAHASHI, Shizuoka (JP); Takashi MATSUNAGA, Shizuoka (JP); Keigo TSUBO, Shizuoka (JP); Masayoshi TAKAYANAGI, Shizuoka (JP); Shingo HAMADA, Tokyo (JP); Daiki AMEMIYA, Tokyo (JP); Kenji KAJIKAWA, Tokyo (JP)

(73) Assignee: Yazaki Corporation, Tokyo (JP)

(21) Appl. No.: 18/982,385

(22) Filed: Dec. 16, 2024

(30) Foreign Application Priority Data
Jan. 31, 2024 (JP) 2024-012777

(51) Int. Cl. H01B 7/00; H01R 12/81

(52) U.S. Cl. CPC H01B 7/0045; H01R 12/81

(57) ABSTRACT

A wire harness includes: a connector including a plurality of terminals having insertion portions, and a terminal holding part that holds the plurality of terminals arranged in a plurality of rows in a state where the insertion portions protrude therefrom; and a planar routing member including a flat plate-shaped flexible printed board part having flexibility, with a plurality of through holes formed therein to be physically and electrically connected to the terminals through the through holes, in which the flexible printed board part is disposed to cover an end surface from which the insertion portions of the plurality of terminals protrude in the terminal holding part, and is physically and electrically connected to the insertion portions via solders in a state where the insertion portions of the terminals corresponding to the plurality of through holes are inserted into the plurality of through holes, respectively.

### CROSS-REFERENCE TO RELATED APPLICATION(S)

The present application claims priority to and incorporates by reference the entire contents of Japanese Patent Application No. 2024-012777 filed in Japan on Jan. 31, 2024.

### BACKGROUND OF THE INVENTION

### 1. Field of the Invention

The present invention relates to a wire harness.

### 2. Description of the Related Art

Conventionally, a rigid-flexible board in which a flexible printed board part having flexibility and a rigid board part on which an electronic component is mounted are integrated has been known. In addition, Japanese Patent No. 5907129 discloses a technology related to an electronic circuit board built-in connector including an electronic circuit board provided with a first connection terminal, an inner case, an outer case in which a space is provided to allow the inner case to be inserted from the outside, a second connection terminal extending from the inside of the space to the outside of the outer case, and a wire connected to a sensor at one end thereof outside the outer case and connected to a third connection terminal disposed inside the space at the other end thereof. In Japanese Patent No. 5907129, the electronic circuit board is sealed by a resin in the inner case in a state where the first connection terminal is exposed, the inner case is housed in the space of the outer case, the second connection terminal and the third connection terminal are connected to the first connection terminal, and the space is closed by a lid. In Japanese Patent No. 5907129, heat-resistant reliability and signal reliability can be improved by the above-described configuration.

However, when a plurality of conductive members such as terminals are soldered to a planar routing member such as a rigid-flexible board, if the soldering is performed for each conductive member, there is a possibility that soldering precision may vary.

### SUMMARY OF THE INVENTION

An object of the present invention is to provide a wire harness capable of appropriately soldering a plurality of conductive members to a planar routing member.

In order to achieve the above mentioned object, a wire harness according to one aspect of the present invention includes a connector including a plurality of terminals having insertion portions, and a terminal holding part that holds the plurality of terminals arranged in a plurality of rows in a state where the insertion portions protrude therefrom; and a planar routing member including a flat plate-shaped flexible printed board part having flexibility, with a plurality of through holes formed therein to be physically and electrically connected to the terminals through the through holes, wherein the flexible printed board part is disposed to cover an end surface from which the insertion portions of the plurality of terminals protrude in the terminal holding part, and is physically and electrically connected to the insertion portions via solders in a state where the insertion portions of the terminals corresponding to the plurality of through holes are inserted into the plurality of through holes, respectively.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness according to an embodiment;

FIG. 2 is an exploded perspective view illustrating the wire harness according to the embodiment;

FIG. 3 is a plan view illustrating a planar routing member according to the embodiment;

FIG. 4 is a flowchart illustrating a process of manufacturing the wire harness according to the embodiment;

FIG. 5 is a perspective view illustrating a terminal accommodating step in the embodiment;

FIG. 6 is a perspective view illustrating a laser irradiating step in the embodiment;

FIG. 7 is a perspective view illustrating a bending step in the embodiment; and

FIG. 8 is a perspective view illustrating a housing accommodating step in the embodiment.

### DETAILED DESCRIPTION OF THE PREFERRED EMBODIMENTS

Hereinafter, a wire harness according to an embodiment of the present invention will be described in detail with reference to the drawings. Note that the present invention is not limited by the present embodiment. In addition, the components in the following embodiment include those that can be easily imagined by those skilled in the art or those that are substantially the same.

### Embodiment

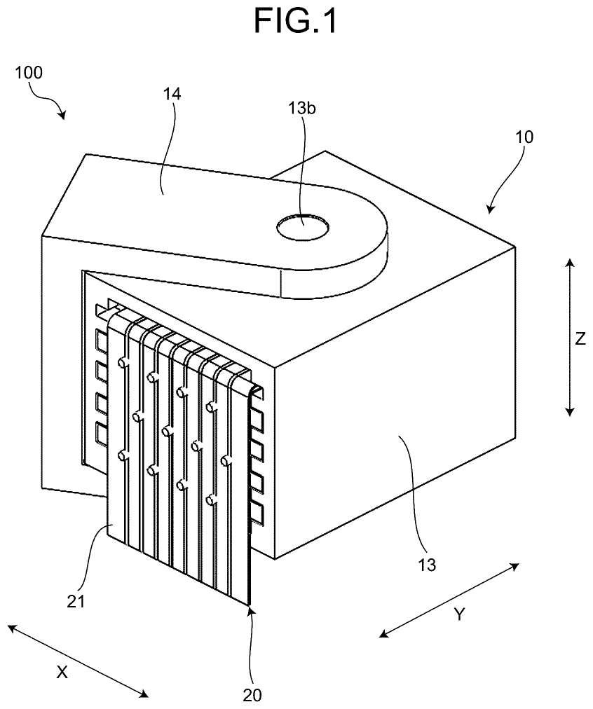

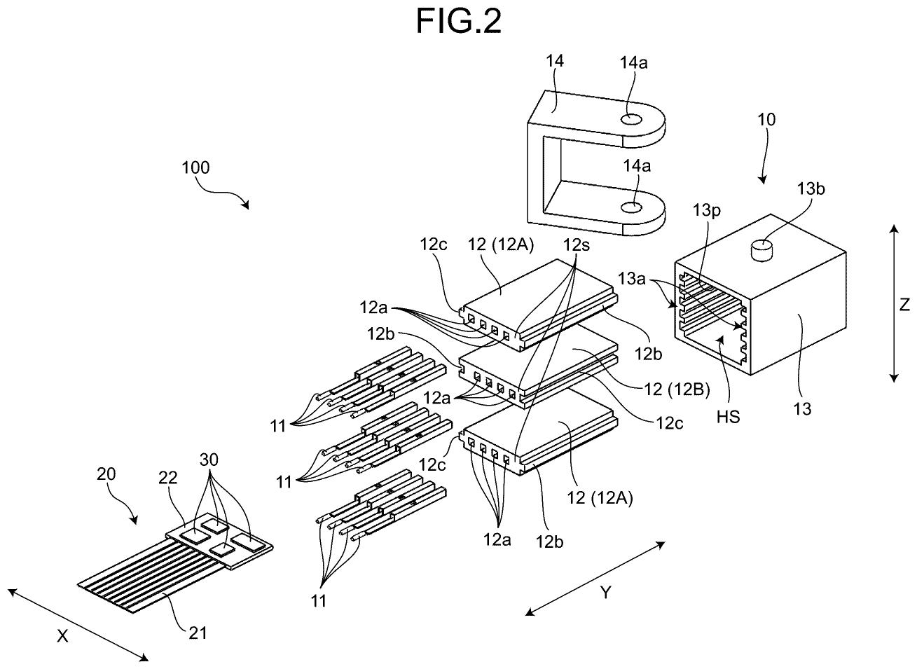

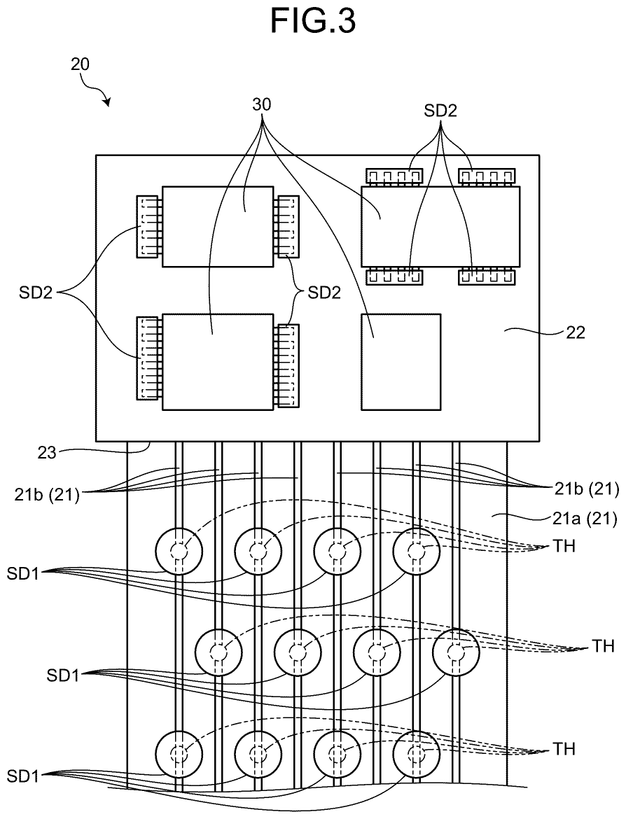

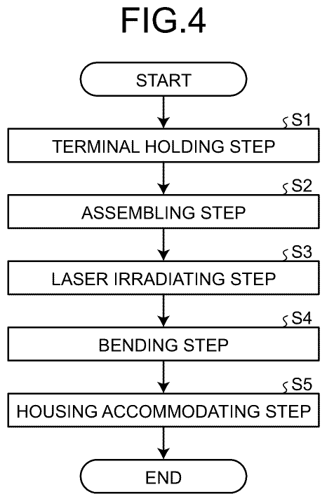

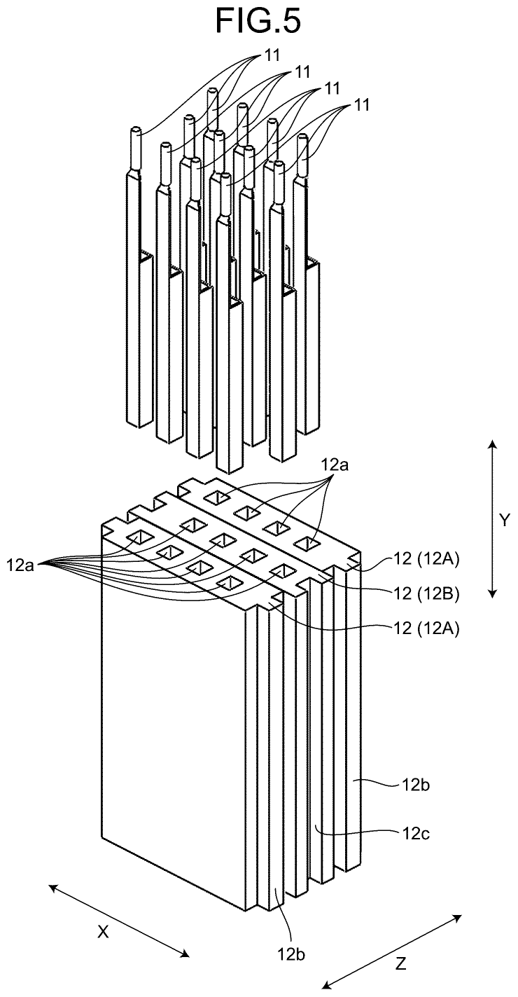

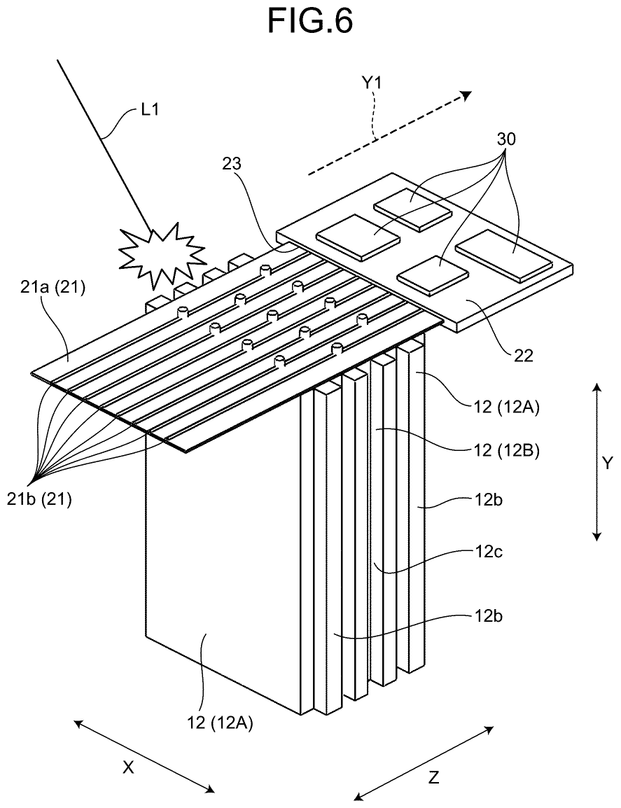

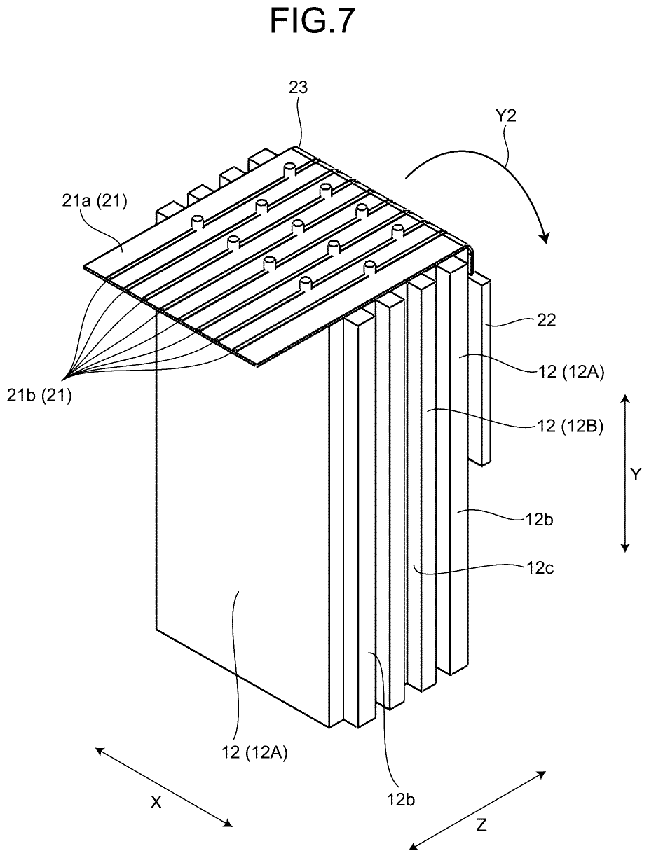

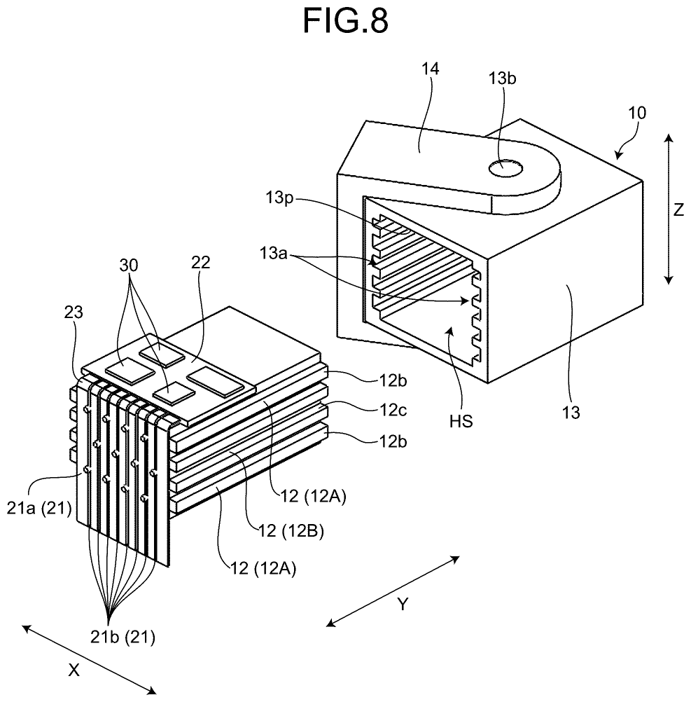

An embodiment will be described with reference to FIGS. 1 to 8. The present embodiment relates to a wire harness. FIG. 1 is a perspective view illustrating a wire harness according to the embodiment, FIG. 2 is an exploded perspective view illustrating the wire harness according to the embodiment, FIG. 3 is a plan view illustrating a planar routing member according to the embodiment, FIG. 4 is a flowchart illustrating a process of manufacturing the wire harness according to the embodiment, FIG. 5 is a perspective view illustrating a terminal accommodating step in the embodiment, FIG. 6 is a perspective view illustrating a laser irradiating step in the embodiment, FIG. 7 is a perspective view illustrating a bending step in the embodiment, and FIG. 8 is a perspective view illustrating a housing accommodating step in the embodiment.

A wire harness 100 according to the embodiment illustrated in FIG. 1 is mounted on, for example, a vehicle such as an automobile, and electrically connects an electric device of the vehicle to another electric device or the like of the vehicle. As illustrated in FIG. 1, the wire harness 100 according to the embodiment includes a connector 10 and a planar routing member 20.

The connector 10 is fitted to a mating connector (not illustrated). For example, the mating connector is disposed in a housing of a device such as a display or a meter device. The wire harness 100 according to the embodiment connects, for example, a device having a mating connector and a control device that controls the device. The planar routing member 20 includes a printed circuit including a power supply line and a signal line.

As illustrated in FIG. 2, the connector 10 includes a terminal 11, a terminal holding part 12, a housing 13, and a lever 14.

The terminal 11 is a metal terminal fitting. The wire harness 100 according to the embodiment includes a plurality of terminals 11. The terminal 11 includes a square tube-shaped electrical connection portion and a rod-shaped insertion portion protruding from one end of the electrical connection portion. The electrical connection portion of the terminal 11 is a portion to be electrically connected to a terminal of a mating connector. The insertion portion of the terminal 11 is a portion to be inserted into a through hole TH to be described below of the planar routing member 20.

The terminal holding part 12 is a member that accommodates and holds the terminals 11, and is molded from an insulating material such as a resin. A plurality of terminal accommodation holes 12a are formed in an end surface 12s of the terminal holding part 12 of the embodiment. The terminal accommodation holes 12a penetrate the terminal holding part 12 in a direction in which the connector 10 is fitted to a mating connector.

In the terminal holding part 12 of the embodiment, the plurality of terminal accommodation holes 12a are formed in a plurality of rows, and the plurality of terminal accommodation holes 12a in one of the rows adjacent to each other are formed to be shifted in the row direction of the plurality of terminal accommodation holes 12a with respect to the plurality of terminal accommodation holes 12a in the other one of the rows adjacent to each other. That is, the plurality of terminal accommodation holes 12a are arranged in a staggered manner.

In the terminal holding part 12, the terminals 11 are accommodated in the terminal accommodation holes 12a on a one-to-one basis, and at least a part of the rod-shaped insertion portion protrudes from each of the terminal accommodation holes 12a. With this configuration, the terminal holding part 12 holds the plurality of terminals 11 arranged in a plurality of rows in a state where the insertion portions protrude therefrom. In the embodiment, the terminal holding part 12 holds the plurality of terminals 11 arranged in such a manner that the plurality of terminals 11 in one of the rows adjacent to each other are shifted in the row direction of the plurality of terminals 11 with respect to the plurality of terminals 11 in the other one of the rows adjacent to each other. That is, the plurality of terminals 11 are arranged in a staggered manner by being inserted into the terminal accommodation holes 12a corresponding thereto, respectively, of the terminal holding part 12.

In the embodiment, the terminal holding part 12 includes a plurality of flat plate parts 12A and a plurality of flat plate parts 12B having a flat plate shape. The terminal holding part 12 of the embodiment is configured by stacking two flat plate parts 12A and one flat plate part 12B in a plate thickness direction of the flat plate parts 12A and 12B. In the terminal holding part 12 of the embodiment, one flat plate part 12B is stacked to be positioned between two flat plate parts 12A. On the end surface 12s of each of the flat plate parts 12A and 12B, a plurality of terminal accommodation holes 12a (here, four terminal accommodation holes 12a) penetrating each of the flat plate parts 12A and 12B in a direction in which the connector 10 is fitted to a mating connector (a direction in which the terminals 11 are inserted) are arranged in a row.

In the following description, the row direction in which the terminals 11 are arranged in a row in each of the flat plate parts 12A and 12B of the terminal holding part 12 will be referred to as a “first direction X”. The protruding direction in which the insertion portions of the terminals 11 protrude from the terminal holding part 12 will be referred to as a “second direction Y”. The stacking direction in which the flat plate parts 12A and 12B of the terminal holding part 12 are stacked will be referred to as a “third direction Z”. In the embodiment, the first direction X, the second direction Y, and the third direction Z are orthogonal to each other. The first direction X corresponds to a width direction of the connector 10. The second direction Y corresponds to a fitted direction between the connector 10 and the mating connector. The third direction Z corresponds to a height direction of the connector 10.

The terminal holding part 12 of the embodiment is formed such that, when the flat plate parts 12A and 12B are stacked such that the surfaces in which the terminal accommodation holes 12a are formed (the surfaces from which the insertion portions of the terminals 11 protrude) face the same direction, the terminal accommodation holes 12a of the flat plate parts 12A and the terminal accommodation holes 12a of the flat plate part 12B are arranged in a staggered manner in the end surface 12s of the terminal holding part 12. That is, when the flat plate parts 12A and 12B are stacked such that the surfaces in which the terminal accommodation holes 12a are formed face the same direction, the plurality of terminal accommodation holes 12a of the flat plate parts 12A are arranged at positions to be shifted in the first direction X with respect to the plurality of terminal accommodation holes 12a of the flat plate part 12B.

A convex portion 12b to be fitted onto an uneven surface 13a formed on one of the inner side surfaces of the housing 13 to be described below is formed on one side surface of the flat plate part 12A in the first direction X, and a concave portion 12c to be fitted onto an uneven surface 13a formed on the other one of the inner side surfaces of the housing 13 to be described below is formed on the other side surface of the flat plate part 12A in the first direction X. In addition, a concave portion 12c to be fitted onto an uneven surface 13a formed on one of the inner side surfaces of the housing 13 to be described below is formed on one side surface of the flat plate part 12B in the first direction X, and a convex portion 12b to be fitted onto an uneven surface 13a formed on the other one of the inner side surfaces of the housing 13 to be described below is formed on the other side surface of the flat plate part 12B in the first direction X. The flat plate parts 12A and 12B are held by the housing 13 by fitting the convex portions 12b and the concave portions 12c to the uneven surfaces 13a of the inner surfaces of the housing 13.

The housing 13 is a member that accommodates the terminal holding part 12, and is formed of an insulating material such as a resin. The housing 13 of the embodiment is formed in a box shape while being open on the side toward which the insertion portions of the terminals 11 protrude, and includes a housing space HS that holds the flat plate parts 12A and 12B constituting the terminal holding part 12 in a stacked state inside. The terminal holding part 12 (the flat plate parts 12A and 12B) is inserted from an opening 13p of the box-shaped housing 13, and the terminals 11 are held in a state where the insertion portions protrude from the opening 13p of the housing 13. The housing 13 has a plurality of mating terminal insertion holes formed in a surface of the housing 13 opposite to the opening 13p to allow terminals of a mating connector to be inserted thereinto. In the housing 13, the mating terminal insertion holes are formed at positions corresponding to the positions of the electrical connection portions in the plurality of terminals 11, respectively.

The lever 14 is a portion attached to the housing 13 to fit the housing of the connector 10 to a housing of a mating connector by a booster mechanism including the lever 14. That is, the lever 14 is a portion that amplifies a force input to the lever 14, and fits the housing 13 to a mating connector with the amplified force being transmitted to the mating connector.

The housing 13 has two wall portions disposed at positions between which the flat plate parts 12A and 12B in the housing space HS are sandwiched in the stacking direction (the third direction Z) of the flat plate parts 12A and 12B. A cylindrical shaft part 13b is formed on each of the outer side surfaces of the two wall portions of the housing 13. The lever 14 is attached to and rotatably supported by the shaft part 13b.

The planar routing member 20 is a rigid-flexible board including a flexible printed board part 21 and a rigid board part 22.

As illustrated in FIG. 3, the flexible printed board part 21 is a flat plate-shaped circuit body having flexibility. A plurality of through holes TH are formed in the flexible printed board part 21. The plurality of through holes TH are formed to correspond to the insertion portions of the plurality of terminals 11 on a one-to-one basis. A copper foil portion (land) to which a preliminary solder is applied is formed around each of the plurality of through holes TH. The copper foil portion is formed to surround the outer periphery of each of the plurality of through holes TH.

As illustrated in FIGS. 1 and 2, the flexible printed board part 21 is disposed to cover the end surface 12s from which the insertion portions of the plurality of terminals 11 protrude of the terminal holding part 12. The flexible printed board part 21 is physically and electrically connected to the insertion portions of the terminals 11 via solders SD1 in a state where the insertion portions of the terminals 11 corresponding to the plurality of through holes TH are inserted into the plurality of through holes TH, respectively.

The rigid board part 22 is a flat plate-shaped member having higher rigidity than the flexible printed board part 21 and connected to one end of the flexible printed board part 21. In the embodiment, one end of the flexible printed board part 21 and one end of the rigid board part 22 are connected to each other, and the planar routing member 20 is configured as a flat plate-shaped circuit board as a whole. Here, the rigid board part 22 is, for example, a hard printed wiring board. Electronic components 30 are physically and electrically connected to the rigid board part 22 via solders SD2.

As illustrated in FIG. 3, in the planar routing member 20, the flexible printed board part 21 includes a base film 21a and a printed circuit 21b printed on the base film 21a. The printed circuit 21b is a plurality of conductive wires linearly drawn out from the rigid board part 22, and is electrically connected to the electronic components 30 mounted on the rigid board part 22.

In the embodiment, each of the plurality of conductive wires constituting the printed circuit 21b is provided as a linear conductive wire extending along the third direction. Each of the plurality of conductive wires constituting the printed circuit 21b is formed to pass through the land around each of the through holes TH formed in the flexible printed board part 21. With this configuration, the insertion portion of the terminal 11 inserted into the through hole TH is electrically connected to one of the conductive wires passing through the through hole TH via the solder SD1.

In the embodiment, since the plurality of through holes TH are formed in a staggered manner in the flexible printed board part 21, a large number of through holes TH can be densely formed in the base film 21a. That is, the number of through holes TH per unit area in the base film 21a can be increased. Therefore, it is possible to suppress an increase in size of the connector 10 while making the connector 10 multipolar. In addition, the insertion portions of the terminals 11 arranged at different positions in the third direction Z can be electrically connected to the rigid board part 22 by connecting the insertion portions of the terminals 11 with different linear conducting wires. Therefore, since each of the plurality of terminals 11 and the rigid board part 22 can be electrically connected by the linear conductive wire, it is not necessary to create a complicated circuit, making it easy to create the printed circuit 21b.

In the planar routing member 20 of the embodiment, the flexible printed board part 21 has a bent portion 23 bent toward a direction along the second direction Y on one end side where the rigid board part 22 is connected. The rigid board part 22 is disposed to face the terminal holding part 12 in a direction (here, the third direction Z) intersecting the second direction Y as the flexible printed board part 21 is bent at the bent portion 23. That is, in the planar routing member 20 of the embodiment, in a state where the flexible printed board part 21 is bent on one end side where the rigid board part 22 is connected, the flexible printed board part 21 is positioned to face the terminal holding part 12 in the second direction Y, and the rigid board part 22 is positioned to face the terminal holding part 12 in a direction (third direction Z) intersecting the second direction Y.

As illustrated in FIG. 1, the rigid board part 22 is accommodated in the housing space HS of the housing 13, together with the terminal holding part 12, while facing the terminal holding part 12 in a direction (third direction Z) intersecting the protruding direction of the insertion portions with respect to the terminal holding part 12.

Next, a method for manufacturing the wire harness 100 according to the embodiment will be described with reference to FIGS. 4 to 8. As illustrated in FIG. 4, the method for manufacturing the wire harness 100 according to the embodiment includes a terminal holding step S1, an assembling step S2, a laser irradiating step S3, a bending step S4, and a housing accommodating step S5.

As illustrated in FIG. 5, in the terminal holding step S1, the terminals 11 corresponding to the plurality of terminal accommodation holes 12a are inserted into the plurality of terminal accommodation holes 12a, respectively, of the terminal holding part 12. Here, each of the terminals 11 is inserted such that the insertion portion of the terminal 11 protrudes from the end surface 12s exposed from the opening 13p of the housing 13 in the housing accommodating step to be described below. The terminals 11 held by the terminal holding part 12 are arranged such that the leading edge positions of the insertion portions of the plurality of terminals 11 on the end surface 12s of the terminal holding part 12 are located on the same plane. That is, the insertion portions of the plurality of terminals 11 held by the terminal holding part 12 are arranged in a state in which their protrusion lengths from the end surface 12s of the terminal holding part 12 are aligned.

Thereafter, as illustrated in FIG. 6, in the assembling step S2, the planar routing member 20 is assembled to the terminal holding part 12 holding the terminals 11 by inserting the insertion portions of the terminals 11 into the through holes TH of the flexible printed board part 21 in the planar routing member 20. That is, the flexible printed board part 21 is assembled to the terminal holding part 12 by arranging the flexible printed board part 21 to correspond to the surface of the terminal holding part 12 from which the insertion portions of the terminals 11 protrude in the second direction Y. In the assembling step S2, preliminary solders are applied in advance onto the planar routing member 20 to be assembled at connection portions between the insertion portions of the terminals 11 and the flexible printed board part 21 (land portions around the through holes TH) and at connection portions between the electronic components 30 and the rigid board part 22.

Thereafter, in the laser irradiating step S3, the preliminary solders are melted at the connection portions by irradiating the planar routing member 20 with laser, and soldering connections between the flexible printed board part 21 and the terminals 11 and soldering connections between the rigid board part 22 and the electronic components 30 are collectively performed. In the embodiment, the soldering connections of the terminals 11 and the electronic components 30 to the planar routing member 20 are collectively performed by moving the region where laser L1 is irradiated at a constant speed along the third direction Z as indicated by an arrow Y1 in FIG. 6.

Thereafter, in the bending step S4, by bending the flexible printed board part 21 toward the terminal holding part 12 as indicated by an arrow Y2 in FIG. 7 on one end side where the rigid board part 22 is connected, the rigid board part 22 faces the terminal holding part 12 in a direction (third direction Z) intersecting the protruding direction of the insertion portions with respect to the terminal holding part 12.

Thereafter, as illustrated in FIG. 8, in the housing accommodating step S5, the terminal holding part 12 is accommodated in the housing 13 in a state where the planar routing member 20 is assembled thereto and the terminals 11 are held thereby. In the embodiment, the flat plate parts 12A and 12B are inserted into the housing space HS of the housing 13 from the opening 13p of the housing 13 in a state where the flat plate parts 12A and 12B are stacked, thereby holding the flat plate parts 12A and 12B in the housing 13. At this time, the stacked flat plate parts 12A and 12B are inserted such that the convex portions 12b and the concave portions 12c of the flat plate parts 12A and 12B are fitted onto the uneven surfaces 13a of the housing 13. Through the above-described steps, the wire harness 100 according to the embodiment is manufactured.

In the above-described embodiment, the plurality of terminal accommodation holes 12a are arranged in a staggered manner in the terminal holding part 12, but the present invention is not limited to this configuration. For example, in the terminal holding part 12, the plurality of terminal accommodation holes 12a may be arranged in a matrix form.

In addition, in the above-described embodiment, the insertion portion of the terminal 11 has a rod shape, but the present invention is not limited thereto. For example, the insertion portion of the terminal 11 may have a tubular shape.

In addition, the number of flat plate parts 12A and 12B constituting the terminal holding part 12 is not limited to three. For example, the terminal holding part 12 may be configured by stacking two flat plate parts 12A and 12B (that is, one flat plate part 12A and one flat plate part 12B). In addition, the terminal holding part 12 may be configured by stacking four or more flat plate parts 12A and 12B.

In addition, in the above-described embodiment, the terminal holding part 12 and the housing 13 are separate bodies, but the present invention is not limited thereto. For example, the terminal holding part 12 may be formed integrally with the housing 13.

As described above, a wire harness 100 according to the embodiment includes: a connector 10 including a plurality of terminals 11 having insertion portions, and a terminal holding part 12 that holds the plurality of terminals 11 arranged in a plurality of rows in a state where the insertion portions protrude therefrom; and a planar routing member 20 including a flat plate-shaped flexible printed board part 21 having flexibility, with a plurality of through holes TH formed therein to be physically and electrically connected to the terminals 11 through the through holes TH, in which the flexible printed board part 21 is disposed to cover an end surface 12s from which the insertion portions of the plurality of terminals 11 protrude of the terminal holding part 12, and is physically and electrically connected to the insertion portions via solders in a state where the insertion portions of the terminals 11 corresponding to the plurality of through holes TH are inserted into the plurality of through holes TH, respectively.

In the wire harness 100 according to the embodiment, by arranging the plurality of terminals 11 in a plurality of rows and inserting the insertion portions of the terminals 11 into the through holes TH of the flexible printed board part 21, solders connecting the terminals 11 and the flexible printed board part 21 can be collectively irradiated with laser. With this configuration, the soldering connections can be uniformly performed without adjusting the laser output. Therefore, in the wire harness 100 according to the embodiment, the plurality of terminals 11 can be appropriately soldered to the flexible printed board part 21 of the planar routing member 20.

In addition, in the wire harness 100 according to the embodiment, the planar routing member 20 further includes a flat plate-shaped rigid board part 22 connected to one end of the flexible printed board part 21 and having higher rigidity than the flexible printed board part 21, with electronic components 30 being physically and electrically connected thereto via solders, and in a state where the flexible printed board part 21 is bent on one end side, the flexible printed board part 21 is positioned to face the terminal holding part 12 in a protruding direction of the insertion portions with respect to the terminal holding part 12, and the rigid board part 22 is positioned to face the terminal holding part 12 in a direction intersecting the protruding direction.

In the wire harness 100 according to the embodiment, the planar routing member 20 includes the flat plate-shaped rigid board part 22 on which electronic components 30 are mounted, and the flexible printed board part 21 is configured to be bendable in the planar routing member 20. With this configuration, for example, not only solders connecting the flexible printed board part 21 and the terminals 11 but also solders connecting the rigid board part 22 and the electronic components 30 can be collectively irradiated with laser. In the wire harness 100 according to the embodiment, by bending the flexible printed board part 21, the rigid board part 22 becomes facing and overlapping the terminal holding part 12 in the direction intersecting the protruding direction of the insertion portions. By doing so, for example, the rigid board part 22 can be accommodated in the housing 13 or the like in a state where the rigid board part 22 overlaps the terminal holding part 12, reducing the size of the wire harness 100. In addition, with the configuration in which the electronic components 30 are mounted on the rigid board part 22 adjacent to the flexible printed board part 21, the influence of vibration caused by a fit rattle between the connector and a mating connector can be suppressed.

In the wire harness 100 according to the embodiment, the terminal holding part 12 includes a plurality of flat plate parts 12A and 12B having a flat plate shape, each holding the plurality of terminals 11 in one of the rows, and the connector 10 further includes a housing 13 that holds the plurality of flat plate parts 12A and 12B stacked in a plate thickness direction of the plurality of flat plate parts 12A and 12B in a state where the end surface 12s of the terminal holding part 12 is exposed outward.

In the wire harness 100 according to the embodiment, by stacking the plurality of flat plate parts 12A and 12B, the number of terminals 11 connected to the planar routing member 20 can be increased, making it possible to suppress an increase in size of the connector 10 while making the connector 10 multipolar.

In the wire harness 100 according to the embodiment, the terminal holding part 12 holds the plurality of terminals 11 arranged in such a manner that the plurality of terminals 11 in one of the rows adjacent to each other are shifted in a row direction of the plurality of terminals 11 with respect to the plurality of terminals 11 in the other one of the rows adjacent to each other.

In the wire harness 100 according to the embodiment, by arranging the terminals 11 in such a manner that their relative positions are shifted between the rows, an operator can easily check whether the flexible printed board part 21 and the terminals 11 are appropriately connected to each other by soldering. In addition, with this configuration, the terminals 11 can be arranged more compactly and densely.

The contents disclosed in the above-described embodiment can be executed in appropriate combinations.

The wire harness according to the present embodiment is advantageous in that a plurality of conductive members can be appropriately soldered to the planar routing member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a connector including a plurality of terminals having insertion portions, and a terminal holding part that holds the plurality of terminals arranged in a plurality of rows in a state where the insertion portions protrude therefrom; and
a planar routing member including a flat plate-shaped flexible printed board part having flexibility, with a plurality of through holes formed therein to be physically and electrically connected to the terminals through the through holes, wherein
the flexible printed board part is disposed to cover an end surface from which the insertion portions of the plurality of terminals protrude in the terminal holding part, and is physically and electrically connected to the insertion portions via solders in a state where the insertion portions of the terminals corresponding to the plurality of through holes are inserted into the plurality of through holes, respectively.

2. The wire harness according to claim 1, wherein
the planar routing member further includes a flat plate-shaped rigid board part connected to one end of the flexible printed board part and having higher rigidity than the flexible printed board part, with electronic components being physically and electrically connected thereto via solders, and in a state where the flexible printed board part is bent on one end side, the flexible printed board part is positioned to face the terminal holding part in a protruding direction of the insertion portions with respect to the terminal holding part, and the rigid board part is positioned to face the terminal holding part in a direction intersecting the protruding direction.

3. The wire harness according to claim 1, wherein
the terminal holding part includes a plurality of flat plate parts having a flat plate shape, each holding the plurality of terminals in one of the rows, and
the connector further includes a housing that holds the plurality of flat plate parts stacked in a plate thickness direction of the plurality of flat plate parts in a state where the end surface of the terminal holding part is exposed outward.

4. The wire harness according to claim 2, wherein
the terminal holding part includes a plurality of flat plate parts having a flat plate shape, each holding the plurality of terminals in one of the rows, and
the connector further includes a housing that holds the plurality of flat plate parts stacked in a plate thickness direction of the plurality of flat plate parts in a state where the end surface of the terminal holding part is exposed outward.

5. The wire harness according to claim 1, wherein
the terminal holding part holds the plurality of terminals arranged in such a manner that the plurality of terminals in one of the rows adjacent to each other are shifted in a row direction of the plurality of terminals with respect to the plurality of terminals in the other one of the rows adjacent to each other.

6. The wire harness according to claim 2, wherein
the terminal holding part holds the plurality of terminals arranged in such a manner that the plurality of terminals in one of the rows adjacent to each other are shifted in a row direction of the plurality of terminals with respect to the plurality of terminals in the other one of the rows adjacent to each other.
